(19) United States
(12) Patent Application Publication
(10) Pub. No.: US 2024/0271672 A1
(43) Pub. Date: Aug. 15, 2024

(54) FLOATING BRAKE CALIPER HAVING PLATE SHAPE SECTION FOR RESTING AGAINST BRAKE PAD AS WELL AS TOOL AND METHOD FOR MACHINING THE SAME

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/415,228

(22) Filed: Jan. 17, 2024

(30) Foreign Application Priority Data
Feb. 10, 2023 (DE) 102023103290.9

(51) Int. Cl. F16D 55/226

(52) U.S. Cl. CPC F16D 55/226; F16D 2055/0016

(57) ABSTRACT

The invention concerns a floating brake caliper for a vehicle disc brake, the brake caliper comprising a first portion that is arrangeable adjacent to a first side face of a brake disc of the vehicle disc brake and that is configured to receive a brake piston, a second portion that is arrangeable adjacent to a second side face of the brake disc wherein the second portion is configured to rest against a rear face of a brake pad of the vehicle disc brake, and wherein the second portion has a plate-shaped section that is configured to cover a geometric centre of the rear face of the brake pad and to cover at least half of the surface of the rear face of the brake pad and the invention also concerns a toll and method for surface machining of a brake caliper.

### CROSS-REFERENCE TO RELATED APPLICATION

Pursuant to 35 U.S.C. § 119(a), this application claims the benefit of earlier filing date and right of priority to German Patent Application No. 102023103290.9, filed on Feb. 10, 2023, the contents of which are hereby incorporated by reference herein in its entirety.

### BACKGROUND

### 1. Technical Field

The invention concerns a floating brake caliper for a vehicle disc brake, a method for the surface machining of a brake caliper and a tool for the surface machining of a brake caliper.

### 2. Description of the Related Art

Brake calipers are typically used to support and carry at least one brake pad that is movable relative to a braked member. The braked member may in particular be a brake disc of a vehicle disc brake. The brake caliper may also be referred to as a caliper frame or a brake caliper housing. The brake caliper may receive a brake piston and/or may house at least part of a (e.g. electric or hydraulic) brake actuating mechanism. The brake caliper often is a casted metallic part.

Typically, the brake caliper receives and surrounds at least part of the brake disc, such as a radially outer section thereof and/or faces opposite sides of the brake disc. This way, a pair of brake pads that are supported by the brake caliper can be arranged on opposite sides of the brake disc. In a generally known manner, the brake pads can thus clamp the brake disc in between them. For doing so, the brake caliper may be floatingly supported, i.e. may be slidable with respect to a typically fixed brake pad carrier in which the brake pads are slidingly received. DE 10 2005 044 150 A1 discloses an example of such a known configuration.

In such prior art solutions, each brake pad is arranged at one of a first and second inner face of the brake caliper, namely at a so called finger side or piston side of the brake caliper. Said sides lie on opposite sides of the brake disc and/or are spaced apart from one another along a rotational axis of the braked member.

The finger side typically has at least two radially extending distinct fingers or finger portions (e.g. radially with respect to a rotation axis of a brake disc). These are separated by a least one gap, typically a central radially elongated gap. Through said gap, a surface machining tool can be inserted along an axis of displacement of the brake pads. This tool is used to machine inner surfaces of the brake caliper after casting. This relates in particular to inner surfaces of a receiving section that is supposed to receive the brake piston.

The established finger design is usually provided to enable such tool insertion (e.g. along only one straight line) during production of the brake caliper. However, it has been discovered that brake calipers having a respective finger design sometimes do not deliver an optimum brake performance. This relates, for example, to a spatial distribution of a brake pressure generation, vibration characteristics of the brake caliper, its elastic deformation under a brake load and the like.

It is thus an object of this disclosure to provide a bake caliper (as well as a method and tool for surface machining the same) enabling an improved brake performance.

This object is solved by the subject matter according to the independent claims. Advantageous embodiments are defined in this description, in the figures and in the dependent claims.

Accordingly, a floating brake caliper (in other words a brake caliper that is configured to be floating and/or that is configured to be used in a floating caliper brake system) for a vehicle disc brake is disclosed. The brake caliper comprises:
a first portion that is arrangeable is adjacent to (e.g. at or facing) a first side face of a brake disc of the vehicle disc brake and that is configured to receive a brake piston;
a second portion that is arrangeable is adjacent to (e.g. at or facing) a second side face of the brake disc; wherein the second portion is configured to rest against (and in particular to contact) a rear face of a brake pad of the vehicle disc brake, and
wherein the second portion has a plate-shaped section that is configured to cover (or, put differently, overlap with, face or be positioned opposite to) a geometric centre of the rear face of the brake pad and to cover (or, put differently, overlap with, face or be positioned opposite to) at least half of the surface of the rear face of the brake pad. For example, at least 75% or optionally the entire rear face, e.g. apart from optional guiding projections (often called guiding ears) received in a brake pad carrier, may be covered by the plate-shaped section.

The first portion and the second portion may define a sequence of portions along a rotation axis of the brake disc. The first portion may define an outermost axial end portion of the brake caliper when viewed in a first direction of the rotation axis. The second portion may define a different outermost axial end portion of the brake caliper when viewed in an opposite second direction of the rotation axis. In other words, the first portion and the second portion may define opposite outermost axial end portions of the brake caliper.

The first portion may comprise a cylindrical receiving section for receiving the brake piston. Said receiving section may have a circular cross-section. The first portion may comprise at least one annular groove connected to and/or merging with said receiving section for receiving a seal that is configured to establish a fluidically sealing contact with the brake piston.

Additionally or alternatively, the first portion may comprise at least one connection section (e.g. a (e.g. threaded) through-hole or a (e.g. threaded) bore) for connecting to a guide pin. The guide pin may form a guide member along which the a brake pad carrier may slide relative to the brake caliper. The guide pin may be non-movably fixed to the brake caliper. There may be two respective connection section, in particular one at each edge region of a pair of opposite edge regions of the brake caliper.

The second portion of the brake caliper and in particular its plate-shaped section may represent a side that is opposite to and/or faces away from the brake piston. In particular, it may be arranged opposite to a side face of the brake disc that faces away from the brake piston.

The plate-shape section may be a flat or slim section. It may extend at an angle (of e.g. more than 60°) and in particular orthogonally to a displacement axis and/or a rotation axis. A thickness thereof may be smaller (e.g. at least five times smaller or at least ten times smaller) than dimensions (e.g. a width and length) defining its main area or footprint. The thickness may be measured along an axis extending along or in parallel to the brake disc's rotation axis and/or to a displacement axis of the brake piston or brake pads. When referring to a rotations axis or displacement axis herein, this may generally relate to the brake disc's rotation axis and a displacement axis of the brake piston or brake pads, respectively.

A thickness of the plate-shaped section may be uniform or non-uniform. For example, the plate-shaped section may comprise steps or recesses.

The plate-shaped section may have a face, footprint and/or shape (e.g. when viewed along the rotation axis and/or displacement axis) that is configured according to one of the following examples: a rectangular face, footprint and/or shape; a trapezoidal face, footprint and/or shape; a polygonal face, footprint and/or shape having at least one curved side.

The plate-shaped section may contact the rear face of the brake pad. It may be configured to exert a brake force thereon to displace the brake pad and press it against the brake disc. The plate-shaped section may thus generally be configured (e.g. dimensioned and/or made from a suitable material) to transfer brake forces onto the brake pad, the brake force e.g. being generated by the brake piston.

The plate-shaped section (and/or the second portion) may be a one-piece section and/or homogeneous section, e.g. made of a metallic material. Additionally or alternatively, it may be filled or massive, e.g. it may be non-hollow.

The brake pad may have a front face facing the brake disc. Said front face may e.g. comprise a brake lining. The rear face may face away from the brake disc. It may e.g. be metallic and/or comprise a shim.

Covering the geometric centre and/or rear face of the brake pad may include that the plate-shaped section extends along the geometric centre and/or along the rear face. Additionally or alternatively, it may include that (e.g. when viewed along the rotation axis of the brake disc and/or the displacement axis of the brake piston or brake pad) the plate-shaped section is located opposite to the geometric centre and/or opposite to the rear face of the brake pad or overlaps therewith.

By providing a respectively dimensioned and arranged plate-shaped section, the so far established brake caliper design comprising a plurality of distinct finger portions can be avoided or at least suitably adjusted. This limits disadvantages associated with said distinct finger portions. Instead, the presently disclosed central and comparatively large plate-shaped section helps to generate a more uniform pressure distribution along a rear face of the brake pad when pressing it against the brake disc. Further, this pressure distribution may more closely resemble a pressure distribution generated by the brake piston at the respectively opposite brake pad. Thus, the pressures occurring within the brake caliper assembly during braking are more homogeneous, leading to a more homogeneous elastic deformation.

Further, by providing the preferably continuous (or only locally interrupted, i.e. locally opened or locally drilled-through) plate-shaped section instead of a plurality of separate finger portions, the number of eigenfrequencies can be reduced. Additionally, compared to the typically narrower finger sections the plate said section may have a larger axial stiffness. This may be attributed to its increased size in a plane extending orthogonally to the rotation axis and/or to the displacement axis, this size increasing the moment of inertia with respect to said axis.

Still further, it may generally be simpler to machine the surfaces of the plate-shaped section compared to the larger number of smaller surfaces comprised by a plurality of distinct finger portion as typical in the prior art.

According to a further embodiment, the plate-shaped section is the only section of the brake caliper that is configured to cover the rear face of the brake pad. Accordingly, there may be no a plurality of sections extending along a rear of the brake pad as in case of separate finger portions in the prior art. Rather, the plate-shaped section may form a preferably substantially closed (for example only locally perforated or opened, e.g. by single through holes) material section that is arranged opposite to and/or extends along the rear face of the brake pad. This helps to reduce edges or other structural features that complicate machining the surface of the brake caliper e.g. after casting.

Generally, at least 75% or at least 90% of face of the plate-shaped section may be closed. This means that only local interruptions of said otherwise continuous face may be provided, e.g. in form of cut-outs or drillings. This improves stability.

In another aspect, the plate-shaped section is the largest section of the second portion that extends radially inwards with respect to a rotation axis of a brake disc of the vehicle disc brake. In this context, the size of a surface facing the brake pad may be considered to determine said largest section. In particular, the plate-shaped section may be the only section of the second portion that extends radially inwards with respect to a rotation axis of a brake disc of the vehicle disc brake. For example, the second portion may in its entirety be formed by the plate-shaped section. Alternatively, it may only comprise a further section adjacent to a bridge portion connecting the brake caliper's first and second portion, said further section e.g. connecting the plate-shaped section and the bridge portion.

The bridge portion may axially span across the brake disc. It may connect radially upper edge regions of the first portion and the second portion.

In one example, the plate-shaped section intersects a longitudinal axis of the receiving section and/or a displacement axis of the brake piston received in the receiving section and/or a displacement axis of the brake pad. These axes may extend parallel to and/or coincide with one another. By positioning the plate shaped section accordingly, the local distribution of the pressure forces generated at a pair of brake pads comprised by the brake caliper can be made more equal. Specifically, the distribution of pressure forces generated by the plate-shaped section at the rear face of its adjacent brake pad may be more similar to a respective distribution generated by the brake piston at another brake pad adjacent to said brake piston. That is, compared to existing finger portions, the brake pads arranged on the different sides of the brake disc may experience more equal brake pressures. This may be beneficial e.g. in terms of vibration and elastic deformation characteristics of the brake caliper.

According to one embodiment, at least half of the plate-shaped section has a uniform thickness. This may relate to at least half of the area of the plate-shaped section that faces the brake pad. Alternatively, a volume of the plate-shaped section may be considered with at least half of said volume being comprised by a portion of the plate-shaped section having a uniform thickness. The uniform thickness may improve uniformity of e.g. the deformation characteristics of the plate-shaped section and/or of the pressure exerted thereby onto the brake pad during braking.

It may be provided that the plate-shape section is filled meaning it is non-hollow. This may increase stiffness, in particular at a limited thickness of the plate-shape section.

According to one embodiment, the first portion and the second portion are integrally formed. For example, they may be casted. Generally, the brake caliper may be a one-piece member and in particular a casted part. Accordingly, the first portion, an optional bridge portion and the second portion may be comprised by a one-piece member e.g. having a homogenous and/or uniform material composition. In particular, the brake caliper may comprise or consist of a metallic material, such as aluminium or cast iron.

The invention further concerns a vehicle disc brake, comprising:
a brake caliper according to any of the previous aspects,
a brake pad carrier that is slidable relative to the brake caliper,
a pair of brake pads that are slidingly received in the brake pad carrier,
   wherein the plate-shaped section of the brake caliper is arranged to cover a geometric centre of the rear face of one of the brake pads and to cover at least half of the surface of the rear face of the brake pad.

The invention also concerns a method for surface machining of a brake caliper, the brake caliper comprising:
a first portion that is arrangeable adjacent to a first side face of a brake disc of the vehicle disc brake and that is configured to receive a brake piston;
a second portion that is arrangeable adjacent to a second side face of the brake disc;
a bridge portion connecting the first portion and second portion (e.g. at respective radially upper edges thereof);
a gap extending opposite the bridge portion and in between (e.g. radially) lower edges of the first portion and second portion;
the method comprising:
inserting at least part of a tool for machining surfaces of the brake caliper through said gap into the brake caliper; and machining at least one surface of the brake caliper with said tool.

This way, the inner surfaces of the brake caliper can be machined even in the absence of any prior art finger portions and a central gap therebetween. Rather, as an insight of this disclosure, it has been determined that the brake caliper's radially inner gap also provides a respective opportunity for reaching the inner surfaces with a tool. In the context of the method, a brake caliper according to any of the examples disclosed herein may be machining. Accordingly, the second portion may comprise a plate-shaped section as discussed herein.

The tool may generally be configured to machine and/or finish metallic surfaces. For example, it may be a milling tool or a grinding tool.

In one embodiment, the method further comprises: adjusting a rotation angle of a rotational joint of the inserted tool, so that a tool head performing the surface machining is arrangeable within the receiving section. The receiving section may form a cavity for receiving the brake piston, wherein the inner surfaces of said cavity have to be machined e.g. to slidingly guide the brake piston and/or to support seals. The receiving section typically extend at an angle to the gap through which the tool is inserted. Figuratively speaking, it may be arranged around the corner relative to said gap. By using a tool with a rotational joint, this relative arrangement of the receiving section and gap (and the insertion direction as defined by the gap) can be compensated for.

Additionally or alternatively, the method may further comprise: extending an elongateable portion of the tool, so that a tool head performing the surface machining is inserteable into the receiving section. In particular, the elongatable portion may be extended after the tool has been inserted and/or after its rotation angle has been adjusted. This helps to maintain a compact size of the tool which may e.g. be necessary during insertion. Afterwards and in particular after adjusting its orientation appropriately by way of the rotational joint, it may be possible to extend the elongateable portion so as to e.g. reach into the receiving section.

The elongateable portion may e.g. comprise a foldable structure and/or a telescope mechanism.

The invention also concerns a tool for the surface machining of a brake caliper. In particular, the tool may be configured according to any of the examples disclosed herein. For example, the tool may comprise a first section and a second section that are connected to one another by a rotational joint. The second section may comprise an elongateable portion that is elongateable to enlarge a distance between the rotational joint and an (e.g. free) end region of the second section. The end region may comprise a tool head for machining a metallic surface of the brake caliper and/or may comprise a mechanical interface to which a respective tool head is connectable.

The tool may also comprise at least one further rotational joint and/or one further rotational degree of freedom e.g. to allow for a rotation of the tool once it is inserted. This helps to enable machining different and in particular opposite surfaces of the brake caliper.

Accordingly, this tool is specifically configured to be inserted through an above-discussed gap of a brake caliper and to reach into a receiving section of the brake caliper.

### BRIEF DESCRIPTION OF THE DRAWINGS

Embodiments of the invention are discussed in the following with respect to the attached schematic figures. Same or similar features may be marked with same reference signs throughout the figures.

FIG. 1 is a sectional view of a vehicle disc brake according to the prior art.

FIG. 2 is a sectional view of a brake caliper according to an embodiment of the invention.

FIG. 3 is a side view of the brake caliper of FIG. 1.

FIGS. 4-6 illustrate alternative configurations of the plate-shape section of a brake caliper according to further embodiments of the invention.

FIG. 7 shows a tool according to an embodiment of the invention for machining surfaces of the brake caliper, the tool being in a non-operating state.

FIG. 8 shows the tool of FIG. 7 in an operating state.

FIG. 9 shows another operating state of the tool of FIG. 7

### DETAILED DESCRIPTION OF EMBODIMENTS

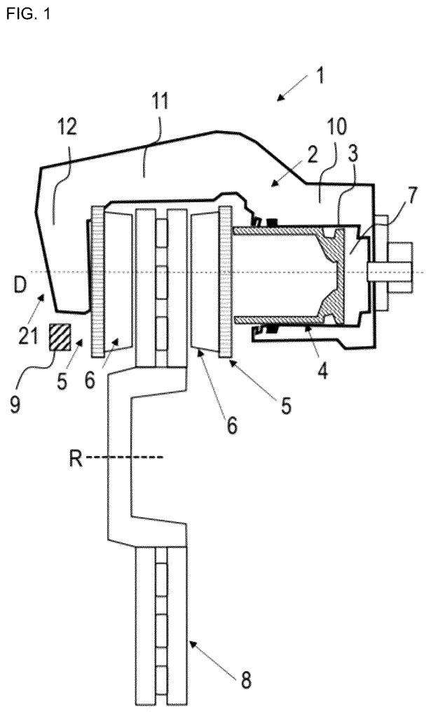

FIG. 1 is a schematic sectional view of a vehicle disc brake 1 according to the prior art. A sectional plane contains a rotations axis R of a brake disc 8 of the vehicle disc brake 1.

The brake disc 8 is coupled to a non-illustrated vehicle wheel for a joint rotation about a rotation axis R. The vehicle disc brake 1 also comprises a brake caliper 2 having a receiving section 3 in which a brake piston 4 is received. The brake piston 4 is displaceable along a displacement axis D by adjusting a pressure in a hydraulic chamber 7 that is jointly delimited by the receiving section 3 and the brake caliper 2. In the shown example, the displacement axis D extends in parallel to the rotation axis R.

The vehicle disc brake 1 also comprises a pair of brake pads 5 arranged on opposite sides of the brake disc 8. Each brake pad 5 comprises a brake lining 6 made of a friction material. The brake piston 4 is configured to contact one of the brake pads 5 in order to exert a force thereon for pressing the brake pad 5 into contact with the brake disc 8. According to known floating caliper principles, the other brake pad 5 is thus forced into contact with the respectively adjacent surface of the brake disc 8.

In this context, the brake pads 5 are displaced along the displacement axis D while being guided by a brake pad carrier 9 of the vehicle disc brake 1. Only a small segment of the brake pad carrier 9 is shown because it largely extends outside of the sectional plane of FIG. 1.

The brake caliper 2 has a first portion 10 extending on a first side of the brake disc 8 and comprising the receiving section 3. The brake caliper 2 has a second portion 12 extending on the respective opposite second side of the brake disc 8. The first portion 10 and second portion 12 are connected by a bridge portion 11 extending along the displacement axis D and spanning across the brake disc 8 from one side to the other. Generally, the brake caliper 2 is a one-piece casted metallic member, so that the first portion 10, the second portion 12 and the bridge portion 11 are integrally formed.

The second portion 12 rests against a rear face of the brake pad 5 on the side of the brake disc 8 facing away from the brake piston 4. The rear face of the brake pad 5 faces away from the brake disc 8 and does not comprise the friction lining 6 (which is instead provided at a front face of the brake pad 5).

According to known configurations, the second portion 12 comprises a plurality of finger portions 21, only one of which is visible in FIG. 1. The previously cited prior art document DE 10 2005 044 150 A1 includes a perspective view of a plurality of finger portions, with a respective arrangement and extension of such finger portions also being provided in the example of FIG. 1.

The finger portions 21 are spaced apart from one another, e.g. when viewed along a circumference of the brake disc 8. This means that in FIG. 1, at least one further finger portion 21 is provided that is located (relative to the image plane) behind or in front of the depicted finger portion 21. Each finger portion 21 is a relatively massive non-hollow material section that projects radially inwards with respect to the rotation axis R.

Each of the finger portions 21 is sized to only overlap with or, in other words, cover a small segment of the area of the brake pad's rear face, e.g. not more than 20% of said area. Also, the finger portions 21 are placed on both sides of the geometric centre of the adjacent brake pad 5. That is, they extend at a distance to said geometric centre opposite to which the gap between the finger portions 21 is placed instead. After casting the brake caliper 2, the non-depicted space in between adjacent finger portions 21 is used to insert a non-depicted tool along the displacement axis D to reach inner surfaces of the receiving section 3.

When the finger portions 21 push the adjacent brake pad 5 against the brake disc 8 during braking, the pressure distribution generated at the rear face of the brake pad 5 is highly non-uniform. Within a contact area to the finger portions 21 and thus outside of the geometric centre of said rear face, the pressure is high, whereas outside of said contact portions (and thus at a geometric centre of said rear face), the pressure is low. To the contrary, at a rear face of the brake pad 5 that is in contact with the brake piston 4, the pressure is high in an area including a geometric centre of said rear face, while being low at distances to said geometric centre. Overall, this leads to an asymmetric pressure distribution that negatively affects uniformity of the elastic deformation of the brake caliper 2.

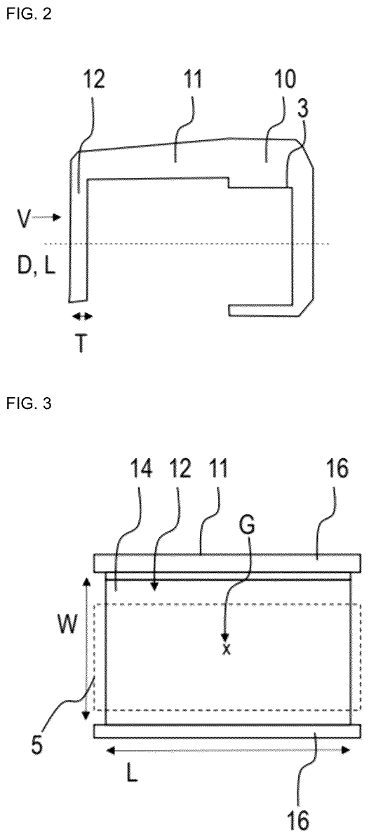

FIGS. 2 and 3 show different views of a brake caliper 2 according to an embodiment of the invention. The brake caliper 2 is generally configured and operates similar to the brake caliper 2 of FIG. 1, apart from the second portion 12 discussed below.

In the sectional view of FIG. 2 (said view being similarly oriented compared to FIG. 1), a receiving section 3, a first portion 10, a bridge portion 11 and a second portion 12 of the brake caliper 2 can again be seen. The second portion 12, however, is comparatively slim. Specifically, when viewed along the displacement axis D, it has a reduced thickness T and/or a reduced material strength compared to the massive finger portions 21 depicted in FIG. 1.

FIG. 2 also shows a longitudinal axis L of the receiving section 3 that coincides with the displacement axis D. The circular cross-section of the receiving section 3 extends concentrically about said longitudinal axis L.

FIG. 3 shows a front view of the second portion 12 with a viewing direction V being indicated in FIG. 2 by a respective arrow. The second portion 12 comprises a plate-shaped section 14 having, only by way of example, a substantially rectangular shape. This relates in particular to an outer face or footprint of the plate-shaped section 14 facing away from the adjacent brake pad 5 and to a similarly sized and dimensioned inner face of the plate-shaped section 14 facing towards the adjacent brake pad 5. These faces extend at an angle to and in particular orthogonally to the longitudinal axis L and displacement axis D. The plate-shaped section 14 is generally closed and massive.

The inner and outer faces of the plate-shaped section 14 have considerably larger dimensions compared to the thickness T indicated in FIG. 2. Specifically, a radial dimension (e.g. a length L) as well as a dimension extending orthogonally to a radial direction (e.g. a width W) are at least two times, at least five times or at least ten times as large as the thickness T. This provides a respective plate shape of the section 14 and ensures a reliable support of the brake pad 5 along a large part of its rear face.

Specifically, a geometric centre G of the adjacent brake pad 5 that is contacted by the plate shaped section 14 is indicated in FIG. 3. It can be seen that the plate-shaped section 14 covers of said geometric centre G or, in other words, overlaps therewith or is arranged oppositely thereto.

FIG. 3 also schematically shows an outline of the rear face of the contacted brake pad 5 (without any optional guiding projections provided thereat). It can be seen that the plate-shaped section 14 covers more than 50% of the area of the rear face of the respectively adjacent brake pad 5. For example, up to 80% of said area (i.e. surface area) is covered.

In FIG. 3, optional outer edge portions 16 of the second portion 22 are shown. These could be omitted and/or merged with or comprised by the plate-shaped section 14. It is noted that the brake caliper 2 of FIGS. 2 and 3 is again a one-piece member that is optionally produced by metal casting. Accordingly, the plate-shaped section 14 is integrally formed with the remainder of the brake caliper 2.

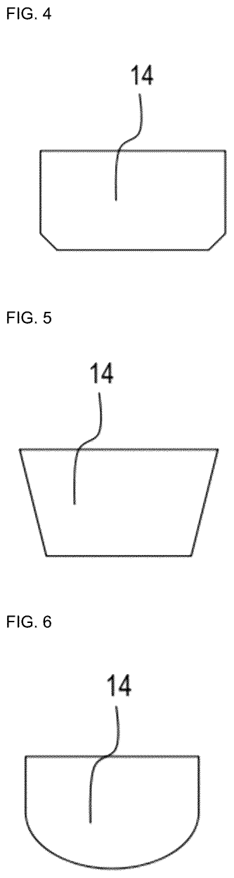

FIGS. 4-6 show alternative configurations of the plate-shaped section 14 which have shapes deviating from the substantially rectangular configuration of FIG. 3. Again, an outer face of the plate-shaped sections 14 facing away from the adjacent brake pad faces the viewer. The inner face of the respective plate-shaped sections is shaped identically.

In FIG. 4, a substantially rectangular shape with radially lower cut-off corners is shown. In FIG. 5, a trapezoidal shape is shown with a shorter side being positioned radially inwards. In FIG. 6, a curved shape is shown or, differently put, a rectangular shape with one side (in particular a radially inward side) thereof being curved. In each of FIGS. 5-6, a width of the plate-shaped section decreases when moving radially inwards. This takes account of an optional similarly decreasing width of non-illustrated-brake pads.

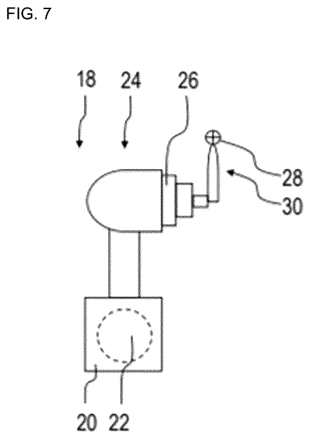

FIG. 7 shows a tool 18 according to an embodiment of the invention. The tool 18 assumes a non-operating resting state. The tool 18 has a first section 23 comprising a base 20. Optionally, a rotational joint 22 of the tool 18 is retractable into the base 20 by a retraction mechanism. FIG. 7 depicts a respectively retracted state. A non-depicted rotation axis of the rotational joint extends orthogonally to the image plane.

The tool 18 comprises a second section 24 connecting the rotational joint 20 and an end region 30. At said end region 30, a tool head 28, such as a milling head, is arranged.

The second section 24 comprises a telescope mechanism 26 so that a distance between the rotational joint 22 and the tool head 28 can be enlarged.

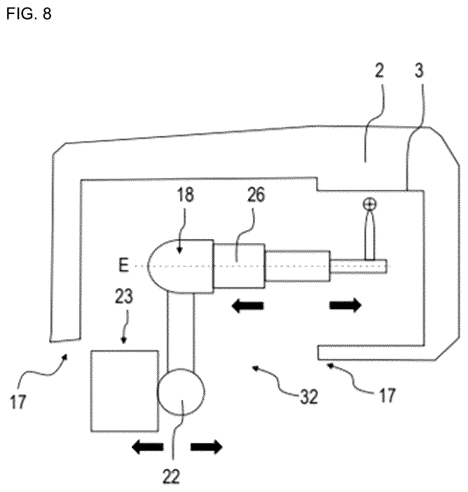

FIG. 8 shows the tool 18 in operation and specifically when inserted into the brake caliper 2 of FIG. 2 to machine inner surfaces of its receiving section 3. The tool 18 is inserted through a radially lower gap 32. This gap 32 extends opposite to the bridge portion 11 and in between the receiving section 3 and the inner face of the second portion 12 of the brake caliper 2. Specifically, it extends in between radially lower edges 17 of the first portion 10 and the second portion 12.

In the depicted operating state, both extendable mechanisms, which each form an elongateable portion of the tool 18, in form of the retraction mechanism connecting the base 20 and the rotational joint 22 and the telescope mechanism 26 are extended. This is indicated by respective arrows in FIG. 8. No specific rotational angle has been set by the rotational joint 22 compared to the state of FIG. 7, but this might be needed to e.g. reach all the way back into the receiving section 3 and/or to reach other surfaces within the brake caliper 2.

FIG. 8 shows an axis E along which the telescope mechanism 28 can move back and forth. This axis e.g. extends orthogonally to the non-illustrated rotation axis of the rotational joint 22. This arrangement of movement axes provides large mobility at a compact size. It is noted that one of the rotational joint 22 and the telescope mechanism 26 could also be omitted

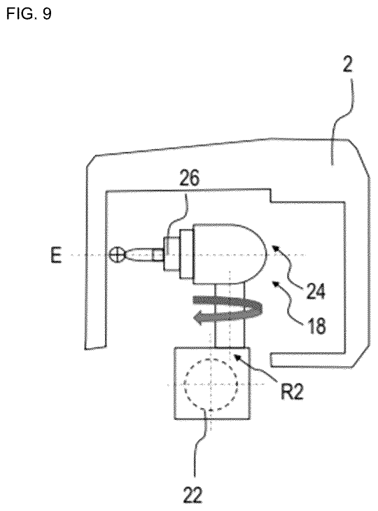

FIG. 9 shows another operating state of the tool 18 for machining also other inner surfaces of the brake caliper 2, said surfaces not being comprised by the receiving section 3. For doing so, the second section 24 optionally comprises another rotational joint 34 e.g. at the base of the telescope mechanism 26. Accordingly, this rotational joint 34 is e.g. positioned in between the (first) rotational joint 22 and the telescope mechanism 26. The rotation axis R2 of said further rotational joint 34 extends e.g. orthogonally to the rotation axis of the (first) rotational joint 22. A respective rotational movement about said rotation axis R2 is indicated by an arrow in FIG. 9.

The further rotational joint 34 increases mobility of the tool 18. Yet, only one of the rotational joints 22, 34 may be provided and/or any of the rotational joints 22, 34 may be positioned differently form the depicted example.

Additionally or alternatively, the (first) rotational joint 22 could also be equipped with a similar rotational degree of freedom as the further rotational joint 34, e.g. by comprising another rotational axis in parallel to the depicted rotation axis R2 of FIG. 9.

What is claimed is:

1. Floating brake caliper for a vehicle disc brake,
the brake caliper comprising:
a first portion that is arrangeable adjacent to a first side face of a brake disc of the vehicle disc brake and that is configured to receive a brake piston;
a second portion that is arrangeable adjacent to a second side face of the brake disc;
wherein the second portion is configured to rest against a rear face of a brake pad of the vehicle disc brake, and
wherein the second portion has a plate-shaped section that is configured to cover a geometric centre of the rear face of the brake pad and to cover at least half of the surface of the rear face of the brake pad.

2. Brake caliper according to claim 1,
wherein the plate-shaped section is the largest and, in particular, the only section of the brake caliper that is configured to cover the rear face of the brake pad.

3. Brake caliper according to claim 1,
wherein the plate-shaped section is the largest and, in particular, the only section of the second portion that extends radially inwards with respect to a rotation axis (R) of a brake disc of the vehicle disc brake.

4. Brake caliper according to claim 1,
wherein the plate-shaped section intersects at least one of:
a longitudinal axis of the receiving section;
a displacement axis of a brake piston received in the receiving section;
a displacement axis of the brake pad.

5. Brake caliper according to claim 1,
wherein at least half of the plate-shaped section has a uniform thickness (T).

6. Brake caliper according to claim 1,
wherein the plate-shape section is non-hollow.

7. Brake caliper according to claim 1,
wherein the brake caliper is a one-piece member.

8. Vehicle disc brake,
comprising:
a brake caliper according to claim 1,
a brake pad carrier that is slidable relative to the brake caliper,
a pair of brake pads that are slidingly received in the brake pad carrier,
wherein the plate-shaped section of the brake caliper is arranged to cover a geometric centre of the rear face of one of the brake pads and to cover at least half of the surface of said rear face.

9. Method for surface machining of a brake caliper,
the brake caliper comprising:
a first portion that is arrangeable adjacent to a first side face of a brake disc of the vehicle disc brake and that is configured to receive a brake piston;
a second portion that is arrangeable adjacent to a second side face of the brake disc;
a bridge portion connecting the first portion and second portion;
a gap extending opposite the bridge portion and in between lower edges of the first portion and second portion;
the method comprising:
inserting at least part of a tool for machining surfaces of the brake caliper through said gap into the brake caliper; and
machining at least one surface of the brake caliper with said tool.

10. Method according to claim 9,
further comprising:
adjusting a rotation angle of a rotational joint of the inserted tool, so that a tool head performing the surface machining is arrangeable within the receiving section.

11. Method according to claim 9,
further comprising:
extending an elongateable portion of the tool, so that a tool head performing the surface machining is inserteable into the receiving section.
